(19) United States
(12) Patent Application Publication
(10) Pub. No.: US 2023/0202816 A1
(43) Pub. Date: Jun. 29, 2023

(54) Pallet Jack Motor Assembly

(71) Applicant: Chateshwar Chandra, Briarwood, NY (US)

(72) Inventor: Chateshwar Chandra, Briarwood, NY (US)

(21) Appl. No.: 17/564,397

(22) Filed: Dec. 29, 2021

(51) Int. Cl. B66F 9/075; B66F 9/065; B60L 53/16

(52) U.S. Cl. CPC B66F 9/07572; B66F 9/065; B60L 53/16

(57) ABSTRACT

A pallet jack motor assembly includes a motor unit that is attachable to a planar surface of a pallet jack. A drive unit is coupled to and angles downwardly from the motor unit and the drive unit is in mechanical communication with the motor unit. The drive unit includes a friction wheel which frictionally engages a wheel on the pallet jack. The friction wheel rotates the wheel on the pallet jack when the motor is turned on thereby facilitating the pallet jack to be powered. In this way the pallet jack can transport a pallet without requiring a user to manually push the pallet jack. A control is removably attachable to a handle of the pallet jack for controlling the drive unit.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to pallet jack devices and more particularly pertains to a new pallet jack device for facilitating a manual pallet jack to be powered with a motor. The device includes a motor that is mountable to a planar surface of a pallet jack and a drive unit that angles downwardly from the motor. The drive unit includes a friction wheel which frictionally engages a wheel of the pallet jack for urging the wheel to rotate in a forward direction or a rearward direction.

### (2) Description of Related Art Including Information Disclosed Under 37 CFR 1.97 and 1.98

The prior art relates to pallet jack devices including a variety of self propelled pallet jacks. The prior art discloses a power unit for a pallet jack that includes a motor which is mounted next to a wheel of a pallet jack and a friction wheel that is directly driven by the motor and which frictionally engages the wheel of the pallet jack for driving the pallet jack. The prior art discloses a method of robotically controlling a motorized pallet jack. The prior art discloses a pallet jack motor that includes a plurality of adapter sleeves for mounting the pallet jack motor to a pallet jack.

### BRIEF SUMMARY OF THE INVENTION

An embodiment of the disclosure meets the needs presented above by generally comprising a motor unit that is attachable to a planar surface of a pallet jack. A drive unit is coupled to and angles downwardly from the motor unit and the drive unit is in mechanical communication with the motor unit. The drive unit includes a friction wheel which frictionally engages a wheel on the pallet jack. The friction wheel rotates the wheel on the pallet jack when the motor is turned on thereby facilitating the pallet jack to be powered. In this way the pallet jack can transport a pallet without requiring a user to manually push the pallet jack. A control is removably attachable to a handle of the pallet jack for controlling the drive unit.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a pallet jack motor assembly according to an embodiment of the disclosure.

FIG. 2 is a top perspective view of an embodiment of the disclosure showing a motor unit and a drive unit mounted to a pallet jack.

FIG. 3 is a back phantom view of an embodiment of the disclosure.

FIG. 4 is a bottom view of an embodiment of the disclosure.

FIG. 5 is a right side in-use view of an embodiment of the disclosure.

### DETAILED DESCRIPTION OF THE INVENTION

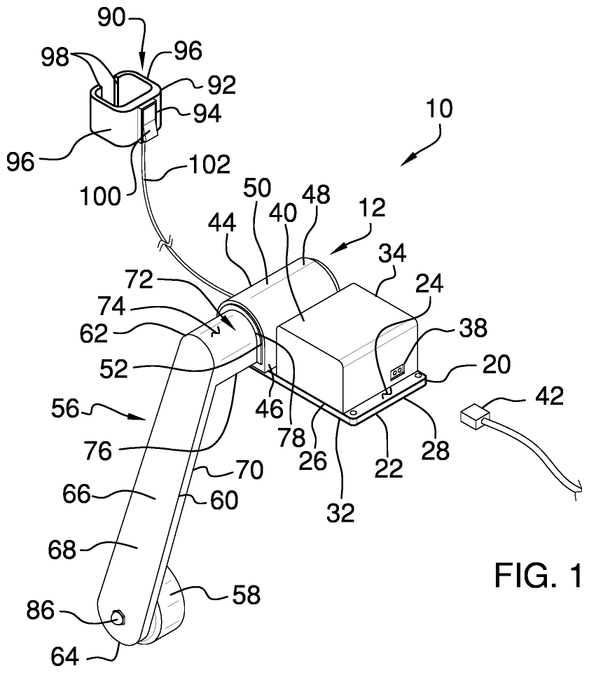

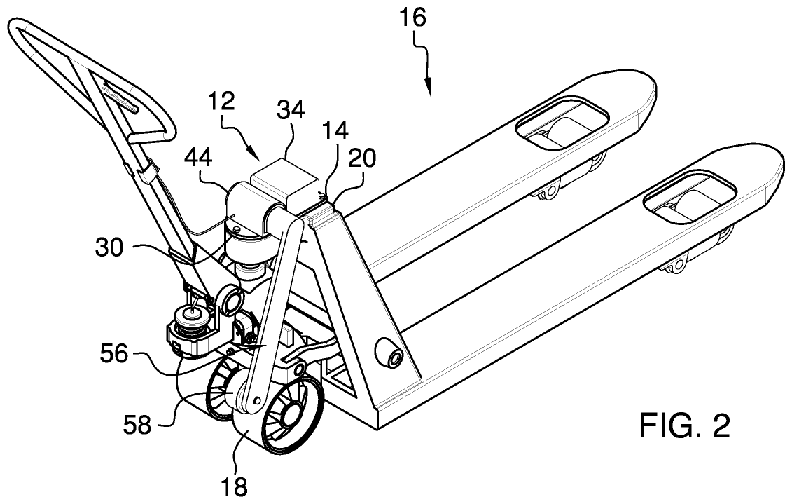

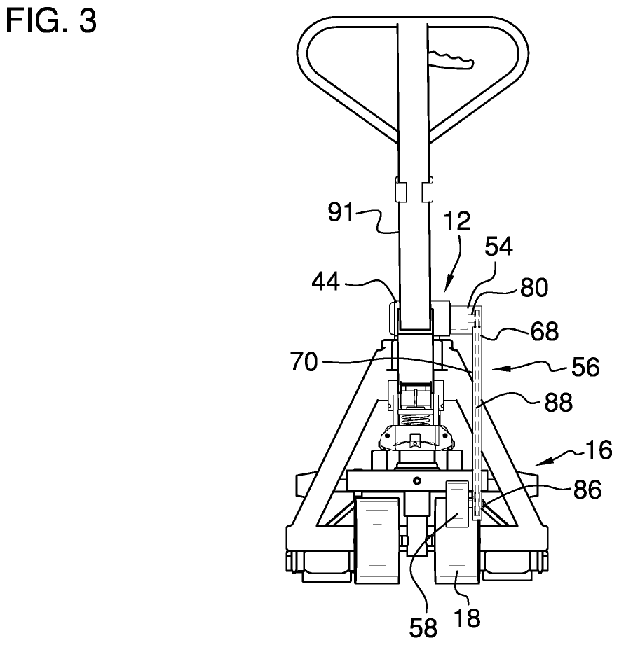

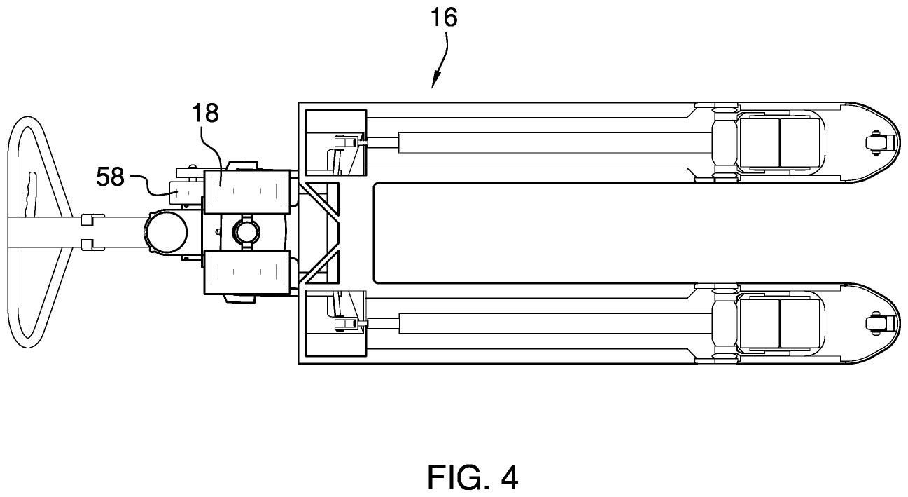

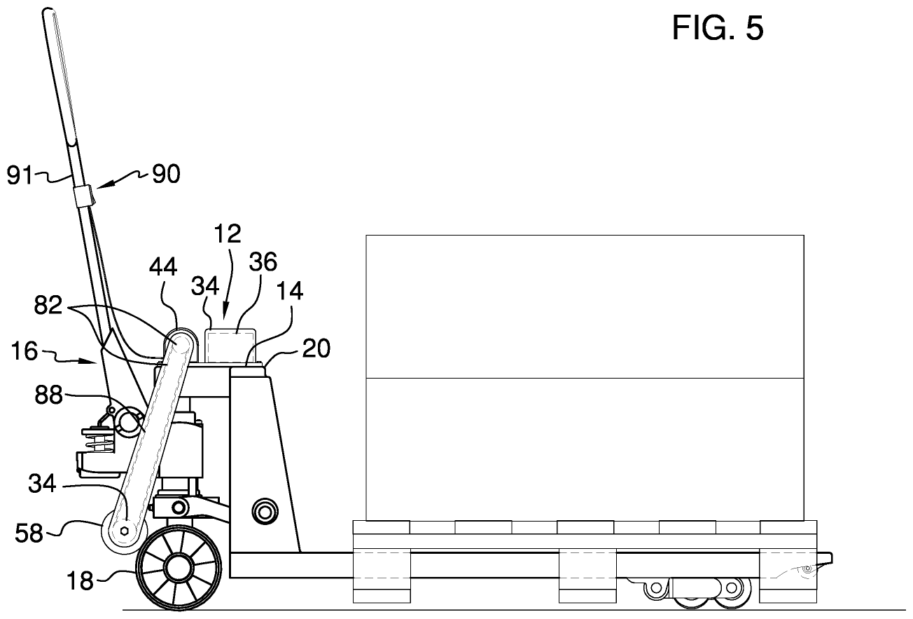

With reference now to the drawings, and in particular to FIGS. 1 through 5 thereof, a new pallet jack device embodying the principles and concepts of an embodiment of the disclosure and generally designated by the reference numeral 10 will be described.

As best illustrated in FIGS. 1 through 5, the pallet jack motor assembly 10 generally comprises a motor unit 12 that is attachable to a planar surface 14 of a pallet jack 16. The pallet jack 16 may be a manually operated pallet jack of any conventional design. The planar surface 14 may be a top end of a frame of the pallet jack 16 or other planar surface that is located near a wheel 18 of the pallet jack 16. The motor unit 12 comprises a plate 20 that has a bottom surface 22, a top surface 24 and a perimeter edge 26 extending between the top surface 24 and the bottom surface 22. The bottom surface 22 rests on the planar surface 14 of the pallet jack 16, and the perimeter edge 26 has a front side 28, a back side 30 and a first lateral side 32.

The motor unit 12 includes a battery housing 34 that is positioned on the top surface 24 of the plate 20. The battery housing 34 is positioned adjacent to the front side 28 of the perimeter edge 26 of the plate 20. The motor unit 12 includes a battery 36 that is positioned within the battery housing 34. A charge port 38 is recessed into an outer wall 40 of the battery housing 34 to receive a charge cord 42 and the charge port 38 is electrically coupled to the battery 36 for charging the battery 36.

The motor unit 12 includes a motor housing 44 that has a lower wall 46 and an outer wall 48 extending upwardly from the lower wall 46. The outer wall 48 of the motor housing 44 has a top side 50 and a first lateral side 52, and the top side 50 is concavely arcuate with respect to the lower wall 46. The lower wall 46 is attached to the top surface 24 of the plate 20 having the motor housing 44 being positioned adjacent to the back side 30 of the perimeter edge 26 of the plate 20. Additionally, the first lateral side 52 of the outer wall 40 is aligned with the first lateral side 32 of the perimeter edge 26 of the plate 20.

The motor unit 12 includes a motor 54 that is positioned within the motor housing 44. The motor 54 extends outwardly through the first lateral side 32 of the outer wall 40 of the motor housing 44. The motor 54 is actuatable to rotate in a first direction or a second direction, and the motor 54 is electrically coupled to the battery 36. The motor 54 may comprise a two direction electric motor or the like.

A drive unit 56 is coupled to and angles downwardly from the motor unit 12 and the drive unit 56 is in mechanical communication with the motor unit 12. The drive unit 56 includes a friction wheel 58 that is rotatably disposed on the drive unit 56 such that the friction wheel 58 is rotated by the motor unit 12. The friction wheel 58 is distally positioned with respect to the motor unit 12 thereby facilitating the friction wheel 58 to frictionally engage the wheel 18 on the pallet jack 16. The friction wheel 58 rotates the wheel 18 on the pallet jack 16 when the motor 54 is turned on thereby facilitating the pallet jack 16 to be powered. In this way the drive unit 56 facilitates the pallet jack 16 to transport a pallet without requiring a user to manually push the pallet jack 16.

The drive unit 56 comprises a drive housing 60 that has a first end 62, a second end 64 and an outside wall 66 extending between the first end 62 and the second end 64, and the drive housing 60 is elongated between the first end 62 and the second end 64. The outside wall 66 has a first sidelong side 68, a second sidelong side 70, and an upper portion 72 extending laterally away from the second sidelong side 70, and the upper portion 72 is aligned with the first end 62. The upper portion 72 has a top surface 74, a bottom surface 76 and a distal surface 78 with respect to the second sidelong side 70, and the top surface 24 is concavely arcuate with respect to the bottom surface 22. The distal surface 78 engages the first lateral side 32 of the outer wall 40 of the motor housing 44 such that the drive housing 60 extends downwardly from the motor housing 44. Additionally, the motor 54 extends into the upper portion 72 such that a drive shaft 80 of the motor 54 is positioned within the upper portion 72. The drive housing 60 is oriented to angle away from the back side 30 of the perimeter edge 26 of the plate 20.

The friction wheel 58 is rotatably disposed on the second sidelong side 70 of the outside wall 66 at a point located adjacent to the second end 64. The friction wheel 58 rotates about an axis extending through the first sidelong side 68 and the second sidelong side 70. A first pulley 82 is rotatably positioned within the drive housing 60. The first pulley 82 is rotatably coupled to the drive shaft 80 of the motor 54 such that the first pulley 82 rotates about an axis extending through the first sidelong side 68 and the second sidelong side 70 of the outside wall 66 of the drive housing 60. A second pulley 84 is rotatably positioned within the drive housing 60. The second pulley 84 is rotatably coupled to an axle 86 that is coupled to the friction wheel 58 such that the second pulley 84 has a common rotational axis with respect to the friction wheel 58.

A belt 88 extends around the first pulley 82 and the second pulley 84 such that the second pulley 84 is rotated when the motor 54 rotates the first pulley 82 thereby facilitating the second pulley 84 to rotate the friction wheel 58. The friction wheel 58 is rotated in a first direction when the motor 54 is actuated to rotate in the first direction thereby facilitating the friction wheel 58 to urge the pallet jack 16 in a forward direction. Conversely, the friction wheel 58 is rotated in a second direction when the motor 54 is actuated to rotate in the second direction thereby facilitating the friction wheel 58 to urge the pallet jack 16 in a rearward direction.

A control 90 is removably attachable to a handle 91 of the pallet jack 16 such that the control 90 is accessible to a user. Furthermore, the control 90 is in communication with the motor unit 12. The motor unit 12 is actuated in a forward condition when the control 90 is actuated in a forward condition thereby facilitating the pallet jack 16 to be driven forwardly. Conversely, the motor unit 12 is actuated in a rearward condition when the control 90 is actuated into a rearward condition thereby facilitating the pallet jack 16 to be driven rearwardly.

The control 90 comprises a clamp 92 that has a central portion 94 extending between a pair of outward portions 96. The outward portions 96 are spaced apart from each other and are perpendicularly oriented with the central portion 94 such that the clamp 92 has a U-shape. Each of the outward portions 96 has a distal end 98 with respect to the central portion 94. Additionally, each of the outward portions 96 is curved adjacent to the distal end 98 such that the distal end 98 of each of the outward portions 96 is directed toward each other. In this way each of the outward portions 96 can wrap partially around the handle 91 for removably retaining the clamp 92 around the handle 91.

The control 90 unit includes a switch 100 that is movably integrated into the clamp 92 such that the switch 100 can be manipulated by the user. The switch 100 is positionable in a forward position, a rearward position or an off position. The control 90 unit includes a conductor 102 which extends between the clamp 92 and the motor housing 44. The conductor 102 is electrically coupled between the switch 100 and the motor 54 such that the switch 100 is in electrical communication with the motor 54. The motor 54 rotates in the first direction when the switch 100 is positioned in the forward position, the motor 54 rotates in the second direction when the switch 100 is positioned in the rearward position and the motor 54 is turned off when the switch 100 is in the off position.

In use, the plate 20 is fastened to the pallet jack 16 with fasteners, such as screws or bolts, and the clamp 92 is positioned around the handle 91. In this way the motor unit 12 and the drive unit 56 can be retrofitted to the pallet jack 16. The switch 100 is positioned in the forward position to facilitate the drive unit 56 to urge the pallet jack 16 in a forward direction. In this way the pallet jack 16 can transport a pallet without requiring the user to manually push the pallet jack 16. The switch 100 is positioned in the rearward position to facilitate the drive unit 56 to urge the pallet jack 16 in a rearward direction. In this way the pallet jack 16 can transport the pallet without requiring the user to manually pull the pallet jack 16. The switch 100 is positioned in the off position to facilitate the pallet jack 16 to remain stationary.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A pallet jack motor assembly for facilitating a pallet jack to be automatically driven, said assembly comprising:
a motor unit being attachable to a planar surface of a pallet jack;
a drive unit being coupled to and angling downwardly from said motor unit, said drive unit being in mechanical communication with said motor unit, said drive unit including a friction wheel being rotatably disposed on said drive unit such that said friction wheel is rotated by said motor unit, said friction wheel being distally positioned with respect to said motor unit thereby facilitating said friction wheel to frictionally engage a wheel on the pallet jack, said friction wheel rotating the wheel on the pallet jack when said motor is turned on thereby facilitating the pallet jack to be powered wherein said drive unit is configured to facilitate the pallet jack to transport a pallet without requiring a user to manually push the pallet jack; and
a control being removably attachable to a handle of the pallet jack wherein said control is configured to be accessible to a user, said control being in communication with said motor unit, said motor unit being actuated in a forward condition when said control is actuated in a forward condition thereby facilitating the pallet jack to be driven forwardly, said motor unit being actuated in a rearward condition when said control is actuated into a rearward condition thereby facilitating the pallet jack to be driven rearwardly.

2. The assembly according to claim 1, wherein said motor unit comprises:
a plate having a bottom surface, a top surface and a perimeter edge extending between said top surface and said bottom surface, said bottom surface resting on the planar surface of the pallet jack, said perimeter edge having a front side, a back side and a first lateral side;
a battery housing being positioned on said top surface of said plate, said battery housing being positioned adjacent to said front side of said perimeter edge of said plate; and
a motor housing having a lower wall and an outer wall extending upwardly from said lower wall, said outer wall having a top side and a first lateral side, said top side being concavely arcuate with respect to said lower wall, said lower wall being attached to said top surface of said plate having said motor housing being positioned adjacent to said back side of said perimeter edge of said plate having said first lateral side of said outer wall being aligned with said first lateral side of said perimeter edge of said plate.

3. The assembly according to claim 2, wherein said motor unit includes:
a battery being positioned within said battery housing;
a charge port being recessed into an outer wall of said battery housing wherein said charge port is configured to receive a charge cord, said charge port being electrically coupled to said battery for charging said battery; and
a motor being positioned within said motor housing, said motor extending outwardly through said first lateral side of said outer wall of said motor housing, said motor being actuatable to rotate in a first direction or a second direction, said motor being electrically coupled to said battery.

4. The assembly according to claim 1, wherein:
said drive unit comprises a drive housing having a first end, a second end and an outside wall extending between said first end and said second end, said drive housing being elongated between said first end and said second end, said outside wall having a first sidelong side and a second sidelong side; and
said outside wall having an upper portion extending laterally away from said second sidelong side, said upper portion being aligned with said first end, said upper portion having a top surface, a bottom surface and a distal surface with respect to said second sidelong side, said top surface being concavely arcuate with respect to said bottom surface.

5. The assembly according to claim 4, wherein:
said motor unit includes a plate having a perimeter edge, said perimeter edge having a back side;
said motor unit includes a motor housing having an outer wall, said outer wall having a first lateral side;
said motor unit includes a motor being positioned within said motor housing;
said distal surface engages said first lateral side of said outer wall of said motor housing such that said drive housing extends downwardly from said motor housing, said motor extending into said upper portion such that a drive shaft of said motor is positioned within said upper portion, said drive housing angling away from said back side of said perimeter edge of said plate, said friction wheel being rotatably disposed on said second sidelong side of said outside wall at a point located adjacent to said second end, said friction wheel rotating about an axis extending through said first sidelong side and said second sidelong side.

6. The assembly according to claim 5, wherein said drive unit includes a first pulley being rotatably positioned within said drive housing, said first pulley being rotatably coupled to said drive shaft of said motor such that said first pulley rotates about an axis extending through said first sidelong side and said second sidelong side of said outside wall of said drive housing.

7. The assembly according to claim 6, wherein said drive unit includes a second pulley being rotatably positioned within said drive housing, said second pulley being rotatably coupled to an axle being coupled to said friction wheel such that said second pulley has a common rotational axis with respect to said friction wheel.

8. The assembly according to claim 7, wherein said drive unit includes a belt extending around said first pulley and said second pulley such that said second pulley is rotated when said motor rotates said first pulley thereby facilitating said second pulley to rotate said friction wheel.

9. The assembly according to claim 8, wherein said friction wheel is rotated in a first direction when said motor is actuated to rotate in said first direction thereby facilitating said friction wheel to urge the pallet jack in a forward direction.

10. The assembly according to claim 9, wherein said friction wheel is rotated in a second direction when said motor is actuated to rotate in said second direction thereby facilitating said friction wheel to urge the pallet jack in a rearward direction.

11. The assembly according to claim 1, wherein said control comprises a clamp having a central portion extending between a pair of outward portions, said outward portions being spaced apart from each other and being perpendicularly oriented with said central portion such that said clamp has a U-shape, each of said outward portions having a distal end with respect to said central portion, each of said outward portions being curved adjacent to said distal end such that said distal end of each of said outward portions is directed toward each other thereby facilitating each of said outward portions to wrap partially around the handle for removably retaining said clamp around the handle.

12. The assembly according to claim 11, wherein said control includes a switch being movably integrated into said clamp wherein said switch is configured to be manipulated by the user, said switch being positionable in a forward position, a rearward position or an off position.

13. The assembly according to claim 12, wherein:
said motor unit includes a motor housing and a motor positioned in said motor housing; and
said control includes a conductor extending between said clamp and said motor housing, said conductor being electrically coupled between said switch and said motor such that said switch is in electrical communication with said motor, said motor rotating in a first direction when said switch is positioned in said forward position, said motor rotating in a second direction when said switch is positioned in said rearward position.

14. A pallet jack motor assembly for facilitating a pallet jack to be automatically driven, said assembly comprising:
a motor unit being attachable to a planar surface of a pallet jack, said motor unit comprising:
a plate having a bottom surface, a top surface and a perimeter edge extending between said top surface and said bottom surface, said bottom surface resting on the planar surface of the pallet jack, said perimeter edge having a front side, a back side and a first lateral side;
a battery housing being positioned on said top surface of said plate, said battery housing being positioned adjacent to said front side of said perimeter edge of said plate;
a battery being positioned within said battery housing;
a charge port being recessed into an outer wall of said battery housing wherein said charge port is configured to receive a charge cord, said charge port being electrically coupled to said battery for charging said battery;
a motor housing having a lower wall and an outer wall extending upwardly from said lower wall, said outer wall having a top side and a first lateral side, said top side being concavely arcuate with respect to said lower wall, said lower wall being attached to said top surface of said plate having said motor housing being positioned adjacent to said back side of said perimeter edge of said plate having said first lateral side of said outer wall being aligned with said first lateral side of said perimeter edge of said plate; and
a motor being positioned within said motor housing, said motor extending outwardly through said first lateral side of said outer wall of said motor housing, said motor being actuatable to rotate in a first direction or a second direction, said motor being electrically coupled to said battery;
a drive unit being coupled to and angling downwardly from said motor unit, said drive unit being in mechanical communication with said motor unit, said drive unit including a friction wheel being rotatably disposed on said drive unit such that said friction wheel is rotated by said motor unit, said friction wheel being distally positioned with respect to said motor unit thereby facilitating said friction wheel to frictionally engage a wheel on the pallet jack, said friction wheel rotating the wheel on the pallet jack when said motor is turned on thereby facilitating the pallet jack to be powered wherein said drive unit is configured to facilitate the pallet jack to transport a pallet without requiring a user to manually push the pallet jack, said drive unit comprising:
a drive housing having a first end, a second end and an outside wall extending between said first end and said second end, said drive housing being elongated between said first end and said second end, said outside wall having a first sidelong side and a second sidelong side, said outside wall having an upper portion extending laterally away from said second sidelong side, said upper portion being aligned with said first end, said upper portion having a top surface, a bottom surface and a distal surface with respect to said second sidelong side, said top surface being concavely arcuate with respect to said bottom surface, said distal surface engaging said first lateral side of said outer wall of said motor housing such that said drive housing extends downwardly from said motor housing, said motor extending into said upper portion such that a drive shaft of said motor is positioned within said upper portion, said drive housing angling away from said back side of said perimeter edge of said plate, said friction wheel being rotatably disposed on said second sidelong side of said outside wall at a point located adjacent to said second end, said friction wheel rotating about an axis extending through said first sidelong side and said second sidelong side;
a first pulley being rotatably positioned within said drive housing, said first pulley being rotatably coupled to said drive shaft of said motor such that said first pulley rotates about an axis extending through said first sidelong side and said second sidelong side of said outside wall of said drive housing;
a second pulley being rotatably positioned within said drive housing, said second pulley being rotatably coupled to an axle being coupled to said friction wheel such that said second pulley has a common rotational axis with respect to said friction wheel; and
a belt extending around said first pulley and said second pulley such that said second pulley is rotated when said motor rotates said first pulley thereby facilitating said second pulley to rotate said friction wheel, said friction wheel being rotated in a first direction when said motor is actuated to rotate in said first direction thereby facilitating said friction wheel to urge the pallet jack in a forward direction, said friction wheel being rotated in a second direction when said motor is actuated to rotate in said second direction thereby facilitating said friction wheel to urge the pallet jack in a rearward direction; and
a control being removably attachable to a handle of the pallet jack wherein said control is configured to be accessible to a user, said control being in communication with said motor unit, said motor unit being actuated in a forward condition when said control is actuated in a forward condition thereby facilitating the pallet jack to be driven forwardly, said motor unit being actuated in a rearward condition when said control is actuated into a rearward condition thereby facilitating the pallet jack to be driven rearwardly, said control comprising:
a clamp having a central portion extending between a pair of outward portions, said outward portions being spaced apart from each other and being perpendicularly oriented with said central portion such that said clamp has a U-shape, each of said outward portions having a distal end with respect to said central portion, each of said outward portions being curved adjacent to said distal end such that said distal end of each of said outward portions is directed toward each other thereby facilitating each of said outward portions to wrap partially around the handle for removably retaining said clamp around the handle;
a switch being movably integrated into said clamp wherein said switch is configured to be manipulated by the user, said switch being positionable in a forward position, a rearward position or an off position; and
a conductor extending between said clamp and said motor housing, said conductor being electrically coupled between said switch and said motor such that said switch is in electrical communication with said motor, said motor rotating in said first direction when said switch is positioned in said forward position, said motor rotating in said second direction when said switch is positioned in said rearward position.

15. A pallet jack motor system for facilitating a pallet jack to be automatically driven, said system comprising:
a pallet jack having at least one wheel and a frame;
a motor unit being attachable to a planar surface of said frame of said pallet jack, said motor unit comprising:
a plate having a bottom surface, a top surface and a perimeter edge extending between said top surface and said bottom surface, said bottom surface resting on said planar surface of said pallet jack, said perimeter edge having a front side, a back side and a first lateral side;
a battery housing being positioned on said top surface of said plate, said battery housing being positioned adjacent to said front side of said perimeter edge of said plate;
a battery being positioned within said battery housing;
a charge port being recessed into an outer wall of said battery housing wherein said charge port is configured to receive a charge cord, said charge port being electrically coupled to said battery for charging said battery;
a motor housing having a lower wall and an outer wall extending upwardly from said lower wall, said outer wall having a top side and a first lateral side, said top side being concavely arcuate with respect to said lower wall, said lower wall being attached to said top surface of said plate having said motor housing being positioned adjacent to said back side of said perimeter edge of said plate having said first lateral side of said outer wall being aligned with said first lateral side of said perimeter edge of said plate; and
a motor being positioned within said motor housing, said motor extending outwardly through said first lateral side of said outer wall of said motor housing, said motor being actuatable to rotate in a first direction or a second direction, said motor being electrically coupled to said battery;
a drive unit being coupled to and angling downwardly from said motor unit, said drive unit being in mechanical communication with said motor unit, said drive unit including a friction wheel being rotatably disposed on said drive unit such that said friction wheel is rotated by said motor unit, said friction wheel being distally positioned with respect to said motor unit thereby facilitating said friction wheel to frictionally engage said at least one wheel on said pallet jack, said friction wheel rotating said at least one wheel on said pallet jack when said motor is turned on thereby facilitating said pallet jack to be powered wherein said drive unit is configured to facilitate said pallet jack to transport a pallet without requiring a user to manually push said pallet jack, said drive unit comprising:
a drive housing having a first end, a second end and an outside wall extending between said first end and said second end, said drive housing being elongated between said first end and said second end, said outside wall having a first sidelong side and a second sidelong side, said outside wall having an upper portion extending laterally away from said second sidelong side, said upper portion being aligned with said first end, said upper portion having a top surface, a bottom surface and a distal surface with respect to said second sidelong side, said top surface being concavely arcuate with respect to said bottom surface, said distal surface engaging said first lateral side of said outer wall of said motor housing such that said drive housing extends downwardly from said motor housing, said motor extending into said upper portion such that a drive shaft of said motor is positioned within said upper portion, said drive housing angling away from said back side of said perimeter edge of said plate, said friction wheel being rotatably disposed on said second sidelong side of said outside wall at a point located adjacent to said second end, said friction wheel rotating about an axis extending through said first sidelong side and said second sidelong side;
a first pulley being rotatably positioned within said drive housing, said first pulley being rotatably coupled to said drive shaft of said motor such that said first pulley rotates about an axis extending through said first sidelong side and said second sidelong side of said outside wall of said drive housing;
a second pulley being rotatably positioned within said drive housing, said second pulley being rotatably coupled to an axle being coupled to said friction wheel such that said second pulley has a common rotational axis with respect to said friction wheel; and
a belt extending around said first pulley and said second pulley such that said second pulley is rotated when said motor rotates said first pulley thereby facilitating said second pulley to rotate said friction wheel, said friction wheel being rotated in a first direction when said motor is actuated to rotate in said first direction thereby facilitating said friction wheel to urge said pallet jack in a forward direction, said friction wheel being rotated in a second direction when said motor is actuated to rotate in said second direction thereby facilitating said friction wheel to urge said pallet jack in a rearward direction; and
a control being removably attachable to a handle of said pallet jack wherein said control is configured to be accessible to a user, said control being in communication with said motor unit, said motor unit being actuated in a forward condition when said control is actuated in a forward condition thereby facilitating said pallet jack to be driven forwardly, said motor unit being actuated in a rearward condition when said control is actuated into a rearward condition thereby facilitating said pallet jack to be driven rearwardly, said control comprising:
a clamp having a central portion extending between a pair of outward portions, said outward portions being spaced apart from each other and being perpendicularly oriented with said central portion such that said clamp has a U-shape, each of said outward portions having a distal end with respect to said central portion, each of said outward portions being curved adjacent to said distal end such that said distal end of each of said outward portions is directed toward each other thereby facilitating each of said outward portions to wrap partially around the handle for removably retaining said clamp around the handle;
a switch being movably integrated into said clamp wherein said switch is configured to be manipulated by the user, said switch being positionable in a forward position, a rearward position or an off position; and
a conductor extending between said clamp and said motor housing, said conductor being electrically coupled between said switch and said motor such that said switch is in electrical communication with said motor, said motor rotating in said first direction when said switch is positioned in said forward position, said motor rotating in said second direction when said switch is positioned in said rearward position.
